(19) United States
(12) Patent Application Publication
(10) Pub. No.: US 2006/0099049 A1
(43) Pub. Date: May 11, 2006

(54) Fastener/stud retainer

(76) Inventor: Rex J. Peterson, Manteno, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/228,676

(22) Filed: Sep. 16, 2005

Related U.S. Application Data
(60) Provisional application No. 60/625,296, filed on Nov. 5, 2004.

(51) Int. Cl. F16B 37/08

(52) U.S. Cl. 411/433

(57) ABSTRACT

A stud retainer that may be used in numerous applications includes features that increase the extraction forces to better retain the stud in the retainer. In an exemplary embodiment, the stud retainer includes a retainer body having retention features that engage the threads on the stud, and wedge projections that, in use, serve to force the retention features into a more secure engagement with stud threads, creating a wedging effect. With the invention, as the threaded stud is attempted to be withdrawn or pulled from the exemplary stud retainer, the retention features move in a direction towards the wedge projections. Once the retention features contact the wedge projections, the wedge projections force the retention features to wedge against the threads of the stud to better secure the stud to the retainer.

### CROSS REFERENCE TO RELATED APPLICATIONS

This Non-Provisional Application claims benefit to U.S. Provisional Application Ser. No. 60/625,296 filed Nov. 5, 2004

### FIELD OF THE INVENTION

The present invention relates generally to fasteners, and more particularly to stud retainers.

### BACKGROUND OF THE INVENTION

It is known that stud retainers are used in various applications. For example, stud retainers have been used with vehicle hoods, cabinet doors, protective covers, and numerous other applications that require repeated engagement and disengagement between two structures. In one known application, a ball-type retainer is mounted to, or threaded onto, a stud, which is mounted to a first structure, such as a vehicle frame. The ball end of the retainer may then engage with a mating grommet or retaining clip, which is mounted to a second structure, such as a vehicle hood. The mating ball and grommet serve as a connection between the first structure and the second structure without any direct contact between the stud and the second structure. The mating ball and grommet connection is also a releasable connection in that upon a predetermined amount of pull-out force, the ball will disengage from the grommet. Because it is important that the connection be releasable, it is desirable to provide a certain amount of force to disconnect the ball from the grommet, without disconnecting or pulling the retainer from the stud.

The present invention is directed at improving upon known stud retainers by providing a retainer having improved pull out strength to prevent the retainer from being pulled from the stud.

### SUMMARY OF THE INVENTION

The present invention is directed to a stud retainer that increases extraction forces to better retain the stud in the retainer. In an exemplary embodiment, the stud retainer includes a retainer body having retention features that engage the threads on the stud, and wedge projections that, in use, serve to force the retention features into a more secure engagement with the stud threads, creating a wedging effect. With the features of the invention, as the threaded stud is attempted to be withdrawn or pulled from the exemplary stud retainer, the retention features move in a direction towards the wedge projections. Once the retention features contact the wedge projections, the wedge projections force the retention features to wedge against the threads of the stud to better secure the stud to the retainer.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a side view an exemplary embodiment of a stud retainer of the present invention.

FIG. 2 is a partial close-up view of the stud retainer of FIG. 1.

FIG. 3 is an isometric view of an exemplary embodiment of a stud retainer of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE EMBODIMENTS

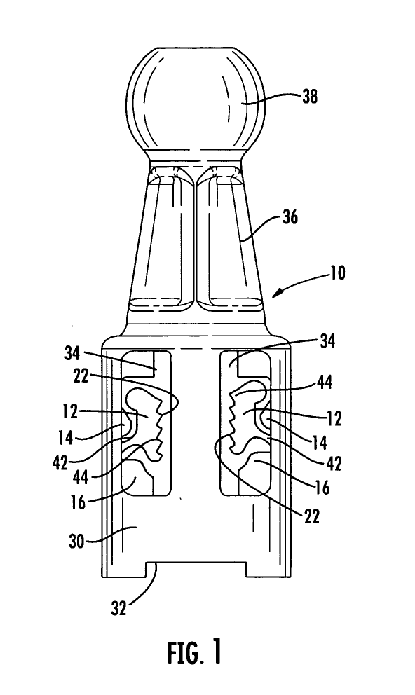

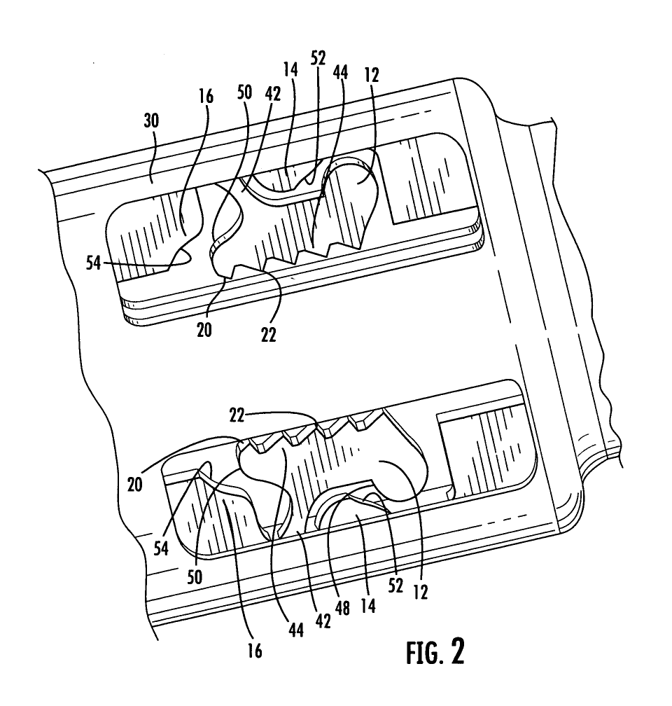

Referring to FIGS. 1 and 2, an exemplary embodiment of a stud retainer of the invention is depicted. The stud retainer of the invention may be used in numerous applications including various automotive applications, door or cover applications, and any other applications that may require the use of a retainer mounted to a stud or fastener. In one embodiment, a retainer 10 includes generally a body having retention features or elements 12 and wedge projections or members 14 and 16. In use, and as described in more detail below, as a threaded stud is attempted to be withdrawn from the stud retainer 10, the retention features 12 move in a direction towards the wedge projections 14 and 16. As the retention features 12 contact the wedge projections 14 and 16, the wedge projections 14 and 16 cause the retention features 12 to wedge up against the threads of the stud to better secure the stud to the retainer 10 and thus to improve the pull out strength of the retainer.

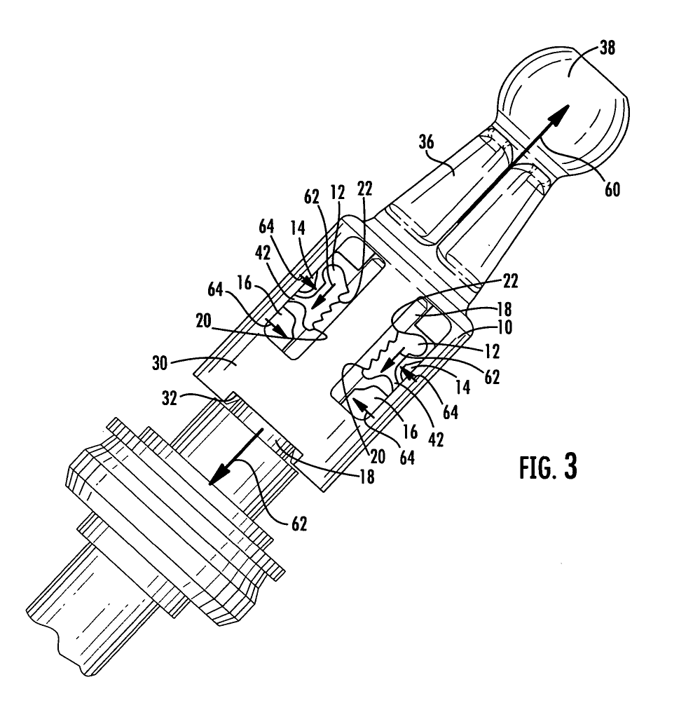

More specifically, referring to FIG. 3, the retainer 10 is shown mounted onto a stud 18. As the stud 18 is pushed into the retainer 10, the retention features 12 are caused to move out of the way by engagement with the stud 18. The retention features 12 include a plurality of teeth 22 or similar engagement members for engagement with the threads on the stud. Once the stud 18 is pushed all the way in, the teeth 22 of the retention features 12 engage the threads of the stud 18. Alternatively, the stud 18 can be threaded into the retainer 10. When the stud 18 is pulled or otherwise caused to move away from the retainer 10, the retention features 12 will move until they come into contact with the associated wedge projections 14 and 16. Once this occurs, the wedge projections 14 and 16 will direct the retention features 12 in towards the stud 18 causing a wedging effect between the threads 24 on the stud 18 and the retention features 12 of the retainer 10, thereby increasing the pull out force of the retainer 10.

Referring back to FIGS. 1 and 2, in an aspect of the invention, the retainer 10 defines a cylindrical body 30 that further defines at one end a cylindrical opening 32 configured to receive a stud or other device. The stud will be inserted through the opening 32, into the cylindrical body 30, and will pass between the retention features 12. The cylindrical body 30 also defines a plurality of openings 34 positioned around the cylindrical body 30.

In an exemplary embodiment, extending outwardly from a second end of the cylindrical body 30 is a ball support post 36 that is connected to a ball 38. The support post 36 may define the illustrated tapered configuration or may define any of the numerous configurations that permit the mounting of the ball 38 to the cylindrical body 30. Depending on the application, the ball 38 is sized and shaped to mount to a grommet, not shown, or some other structure to provide a removable connection between the retainer and accompanying stud, and the grommet or other structure. One skilled in the art will appreciate that other ball types or shapes, as well as other removable connection techniques or structures may be used with the principles of the invention.

Positioned within the cylindrical body 30 and extending radially inwardly from the inner wall of the cylindrical body are the retention features 12. One or more retention feature 12 may be used with the invention depending on the desired application. In one aspect, the retention feature 12 is connected to the inner wall of the cylindrical body 30 through the use of an arm 42 or connection member. The arm 42 is flexible such that it permits movement of the retention features 12 towards and away from the wedge projections 14 and 16. The retention feature 12 defines an end 44 that includes a plurality of teeth 22 that are sized and shaped to engage with the threaded stud as the stud passes across the teeth. The number, size, shape and spacing of the teeth may vary depending on the application. The retention feature 12 further includes entry points 18 with chamfered edges 20 to ease assembly of the stud into the cylindrical body 30. As shown in FIG. 2, the retention feature 12 also includes contoured walls 48, 50 that are configured to contact the wedge projections 14 and 16 as the retainer is pulled away from the stud, as described below.

As shown in FIG. 2, the wedge projections 14 and 16 are positioned within the cylindrical body 30 and extend radially inwardly from the inner wall of the cylindrical body 30. The wedge projection 14 defines a contoured contact surface 52 that is configured to contact the surface 48 of the retention feature 12. Similarly, the wedge projection 16 defines a contoured contact surface 54 that is configured to contact the surface 50 of the retention feature 12. As depicted in FIG. 2, the wedge projections 14 and 16 are located on opposing sides of the arm 42. One skilled in the art will appreciate that other shapes and configurations of the wedge projections 14 and retention features 12 are possible with the invention and that other shapes and configurations of the surfaces 48, 50, 52 and 54 are possible to permit the desired wedging effect of the retention features onto the threaded stud.

Referring to FIG. 3, in use, as the retainer 10 is pulled in the direction indicated by direction arrow 60, the stud 18 and the retention features 12 (due to their engagement with the stud) will move in the direction indicated by direction arrows 62. The flexible arms 42 will permit this directional movement and the retention features 12 will continue to move until they contact the wedge projections 14 and 16 which will stop their continued movement. Once this occurs, the wedge projections 14 and 16 will force the teeth 22 of the retention feature into a wedge-like engagement with the threaded stud 18, as indicated by direction arrows 64. More specifically, the retention features 12 will move towards the wedge projections 14 and 16 until the surface 48 contacts surface 52, and the surface 50 contacts surface 54 at which point the contact surfaces 52, 54 will stop further travel of the retention features 12 and will cause the wedging of the teeth 22 of the retention features 12 to the threaded stud. Significantly, this wedging effect increases the pull-out strength of the stud retainer 10 to prevent the retainer from being pulled from the stud.

When the pulling force exerted on the retainer 10 is reduced or released, the arms 42 will permit the retention features 12 to move away from the wedge projections 14 and 16 and will move the retainer back to its original position. In this position, the retainer can be removed from the threaded stud by unscrewing the retainer from the stud.

Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A stud retainer comprising:
a retainer body defining an inner wall and an opening for receiving a stud,
at least one retention element extending outwardly from the inner wall, the retention element defining an arm and an end forming a plurality of teeth for engagement with the stud, and
at least one wedge projection extending outwardly from the inner wall and positioned on one side of the arm,
whereby the at least one retention element will contact the at least one wedge projection as the stud is pulled from the retainer body causing the plurality of teeth to wedge against the stud to better secure the stud to the retainer body.

2. The stud retainer as set forth in claim 1, wherein the at least one wedge projection is two wedge projections.

3. The stud retainer as set forth in claim 1, wherein the at least one wedge projection defines a contact surface for contacting the at least one retention element.

4. The stud retainer as set forth in claim 1, wherein the arm is flexible to permit movement of the end of the retention element.

5. The stud retainer as set forth in claim 1, wherein the at least one retention element is two retention elements with each retention element defining an end having a plurality of teeth.

6. The stud retainer as set forth in claim 1, wherein the retainer body defines a cylindrical wall, and wherein the at least one retention element and the at least one wedge projection extend radially inwardly from the cylindrical wall.

7. The stud retainer as set forth in claim 1, further comprising a ball support post extending outwardly from the retainer body, and a ball mounted to the ball support post.

8. A stud retainer comprising:
a retainer body defining an inner wall and an opening for receiving a stud,
at least one retention element extending outwardly from the inner wall, the retention element defining a flexible arm and an end forming a plurality of teeth for engagement with the stud,
a first wedge projection extending outwardly from the inner wall and positioned on one side of the arm, and
a second wedge projection extending outwardly from the inner wall and positioned on the other side of the arm,
whereby the at least one retention element will contact the first and second wedge projections as the stud is pulled from the retainer body causing the plurality of teeth to wedge against the stud to better secure the stud to the retainer body.

9. The stud retainer as set forth in claim 8, wherein each of the first and second wedge projections define a contact surface for contacting the at least one retention element.

10. The stud retainer as set forth in claim 8, wherein the at least one retention element is two retention elements with each retention element defining an end having a plurality of teeth.

11. The stud retainer as set forth in claim 8, wherein the retainer body defines a cylindrical wall, and wherein the at least one retention element and the first and second wedge projections extend radially inwardly from the cylindrical wall.

12. The stud retainer as set forth in claim 8, further comprising a ball support post extending outwardly from the retainer body, and a ball mounted to the ball support post.

13. The stud retainer as set forth in claim 8, wherein the at least one retention element includes a chamfered edge.

14. A stud retainer comprising:
a retainer body defining an inner wall and an opening for receiving a stud,
at least one retention element extending outwardly from the inner wall, the retention element defining a flexible arm, an end forming a plurality of teeth for engagement with the stud, and a contoured contact surface,
a first wedge projection extending outwardly from the inner wall and positioned on one side of the arm, the first wedge projection defining a first wedge contoured contact surface, and
a second wedge projection extending outwardly from the inner wall and positioned on the other side of the arm, the second wedge projection defining a second wedge contoured contact surface,
whereby the contoured contact surface of the at least one retention element will contact at least one of the first and second wedge contoured contact surfaces as the stud is pulled from the retainer body causing the plurality of teeth to wedge against the stud to better secure the stud to the retainer body.

15. The stud retainer as set forth in claim 14, wherein at least one of the first and second wedge contoured contact surfaces define a shape that mates with the contoured contact surface of the at least one retention element.

16. The stud retainer as set forth in claim 14, wherein the at least one retention element is two retention elements with each retention element defining an end having a plurality of teeth.

17. The stud retainer as set forth in claim 14, wherein the retainer body defines a cylindrical wall, and wherein the at least one retention element and the first and second wedge projections extend radially inwardly from the cylindrical wall.

18. The stud retainer as set forth in claim 14, further comprising a ball support post extending outwardly from the retainer body, and a ball mounted to the ball support post.

19. The stud retainer as set forth in claim 14, wherein the at least one retention element is two opposing retention elements with each retention element defining an end having a plurality of teeth.

20. The stud retainer as set forth in claim 14, wherein the at least one retention element includes a chamfered edge.
